(19) United States
(12) Patent Application Publication
(10) Pub. No.: US 2026/0246328 A1
(43) Pub. Date: Aug. 20, 2026

(54) CONNECTION STRUCTURE BETWEEN MOTOR AND CABLE

(71) Applicant: Hyundai Kefico Corporation, Gunpo, Gyeonggi-do (KR)

(72) Inventors: Jonghyun Kim, Gunpo, Gyeonggi-do (KR); Huncheol Kang, Gunpo, Gyeonggi-do (KR); Jongchan Lee, Gunpo, Gyeonggi-do (KR); Chanwoo Lee, Gunpo, Gyeonggi-do (KR)

(21) Appl. No.: 18/727,286

(22) PCT Filed: Jul. 21, 2021
(86) PCT No.: PCT/KR2021/009454

§ 371 Date: Feb. 26, 2025

(30) Foreign Application Priority Data
Aug. 12, 2020 (KR) 10-2020-0101294

(51) Int. Cl. H02K 3/52; H02K 11/25

(52) U.S. Cl. CPC H02K 3/522; H02K 11/25

(57) ABSTRACT

The present disclosure relates to a connection structure of a motor and a cable. Disclosed is a connection structure of a motor and a cable, including: a motor comprising a rotor and a stator on which a coil being wound and configured to rotate the rotor according to power supply; a molded body disposed to cover the stator and the coil, provided at an end of the coil, and molded to expose a plurality of terminals, each of which being connected to a plurality of power cables; and a terminal holder coupled to the molded body and configured to fix connection between the terminal and the power cable through a plurality of fastening members fastened by passing through the terminal and the power cable. The molded body is formed as only the stator is molded without an additional connector housing, and thus, the overall volume of the motor is reduced.

### CROSS REFERENCE TO RELATED APPLICATION

The present application claims priority to Korea Patent Application No. 10-2020-0101294, filed on Aug. 12, 2020, the entire contents of which are incorporated herein for all purposes by this reference.

### TECHNICAL FIELD

The present disclosure relates to a connection structure of a motor and a cable, more particularly, a connection structure of a motor in which only a molded body is molded over a stator without an additional connector housing when molding a molded body over a stator so that the overall volume of a motor is reduced.

### BACKGROUND ART

Generally, a motor is configured with a stator module, a rotor module, a circuit board on which circuit elements are mounted, and a motor housing forming an external appearance.

In addition, the motor protects a motor wounding and circuit elements from moisture, uses a BMC molded type motor assembly so as to efficiently dissipate heat generated from the motor wounding, and prevents damage to the motor wounding and the circuit elements due to moisture by molding the stator module of the motor with a BMC (Bulk Molding Compound).

Such a BMC molded type motor assembly is disclosed in Korean patent No. 10-2054950.

The BMC molded type motor assembly according to the prior art has additional components for supporting each lead-wire 300 when forming a BMC molded part 500, such as a connector housing 400 including an upper housing and a lower housing.

However, because the connector housing is provided to ensure engagement of the mold in the BMC molded part, the BMC molded part should be molded and embedded together with the overall stator module and a circuit board, therefore the overall volume increases, and molding of the motor housing as a whole leads to a problem that a coolant flow path cannot be provided inside the motor housing or between the stator and the motor housing.

### PRIOR ART DOCUMENT

### Patent Document

(Patent Document 1) Korean Patent No. 10-2054950

### DISCLOSURE

### Technical Problem

The present disclosure is devised against such backdrop, and an object of the present disclosure is to provide a connection structure of a motor and a cable which has a molded body formed by molding a stator only without an additional connector housing and which can reduce the overall volume of the motor.

In addition, another object of the present disclosure is to provide a connection structure of a motor and a cable, which provides a separate motor housing formed of a material different from a material of a molded body, and is applicable to a water-cooled motor structure by forming a coolant flow path inside the motor housing or between the stator and the motor housing.

Further, still another object of the present disclosure is to provide a connection structure of a motor and a cable, which has a terminal holder over which a molded body is molded and assembled, thereby requires a reduced quantity of components, and allows a stable connection of a coil embedded in the molded body and a power cable.

The objects of the present disclosure are not limited thereto, and another object not mentioned may be precisely understood by those skilled in the art from the description below.

### Technical Solution

One embodiment is a connection structure of a motor and a cable, including: a motor including a rotor and a stator on which a coil being wound and configured to rotate the rotor according to power supply; a molded body disposed to cover the stator and the coil, provided at an end of the coil, and molded to expose a plurality of terminals, each of which being connected to a plurality of power cables; and a terminal holder coupled to the molded body and configured to fix connection between the terminal and the power cable through a plurality of fastening members fastened by passing through the terminal and the power cable.

The molded body may include: a body having a hollow shape and configured to cover the stator and the coil at one side of the stator; a protrusion being a part of the body and configured to protrude toward one side, to allow an end of the coil and a part of the terminal to be embedded therein and to expose a part of the terminal; and a pair of supporting walls configured to support both ends of the terminal holder at both circumferential ends of the protrusion.

In addition, the terminal holder may include: a supporting portion coupled to the molded body to allow the terminal to be seated therein, and on which a plurality of fastening holes allowing the plurality of fastening members to be fastened thereto being formed.

In addition, the molded body may have grooves recessed on inner sides of the pair of supporting walls, and the terminal holder may have a support projection which projects from a surface supported on the supporting wall and are inserted into the groove.

In addition, the terminal holder may further include: a plurality of partitions protruding from the supporting portion and disposed between the plurality of terminals.

In addition, the motor may further include: a temperature sensor insert-molded on an inner side of the protrusion to measure a temperature of the coil and connected to a circuit board through a connection line.

Therefore, the terminal holder may have a space configured to accommodate the connection line on a side opposite to a side of the supporting portion in which the terminal being seated so as to prevent interruption with the connection line.

In addition, the terminal holder may include: a plurality of bosses formed on an opposite surface to the side of the supporting portion in which the terminal being seated, formed at positions corresponding to the plurality of fastening holes to allow the fastening members to be fastened thereto on insides, and spaced apart from each other at a certain interval so as to prevent interruption with the connection line.

In addition, the connection line may be drawn out from an opposite surface facing the rotor at the temperature sensor so as to prevent interruption with the rotor, and folded to be bent and connected to the circuit board.

In addition, the protrusion may have a through groove partially recessed at a protruding tip end surface thereof and allowing the connection line to be inserted thereinto.

In addition, the terminal may include: a fixing portion having a hollow shape surrounding an end of the coil and fixed at the end of the coil; and a connecting portion connected to the fixing portion, having a plate shape facing one surface of the stator, and exposed to an outside to be connected to the power cable when the molded body is molded.

### Advantageous Effect

According to the present disclosure, the overall volume of the motor is reduced because the molded body is formed by molding the stator only, without a separate connector housing.

In addition, the motor housing can be provided separately, therefore, the motor housing can be formed of a material which is different from that of the molded body, and the connection structure can be applied to a water-cooled motor structure by forming a coolant flow path inside the motor housing or between the stator and the motor housing.

Further, there is an effect that the manufacturing process is reduced, a quantity of components are reduced, and a stable connection of a coil embedded in the molded body and a power cable is achieved through a simple configuration, by having a terminal holder over which the molded body is molded and which is mechanically assembled.

### DESCRIPTION OF DRAWINGS

FIG. 1 is a perspective view of a motor having an inner rotor to which a connection structure of a motor and a cable according to an embodiment of the present disclosure is applied.

FIG. 2 is a perspective view of a stator before a bolded body according to an embodiment of the present disclosure is molded thereover.

FIG. 3 is a perspective view illustrating a state in which a molded body is molded over a stator of FIG. 2 and is assembled in a motor.

FIG. 4 is a perspective view illustrating a state after a temperature sensor is connected to a circuit board from a state of FIG. 3.

FIG. 5 is an exploded perspective view of a connection structure of a motor and a cable according to an embodiment of the present disclosure.

FIG. 6 is an enlarged view of A part of FIG. 1.

FIG. 7 is a cross-sectional view of a stator before a molded body according to an embodiment of the present disclosure is molded thereover.

FIG. 8 is an enlarged view of B part of FIG. 7.

FIGS. 9 to 10 are views illustrating a state in which a connection line of a temperature sensor is installed between a molded body and a terminal holder according to an embodiment of the present disclosure.

FIG. 11 is a perspective view of a motor having an outer rotor to which a connection structure of a motor and a cable according to another embodiment of the present disclosure is applied.

### MODE FOR INVENTION

Hereinafter, some aspects of the present disclosure will be described in detail with reference to the accompanying illustrative drawings. In designating elements of the drawings by reference numerals, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

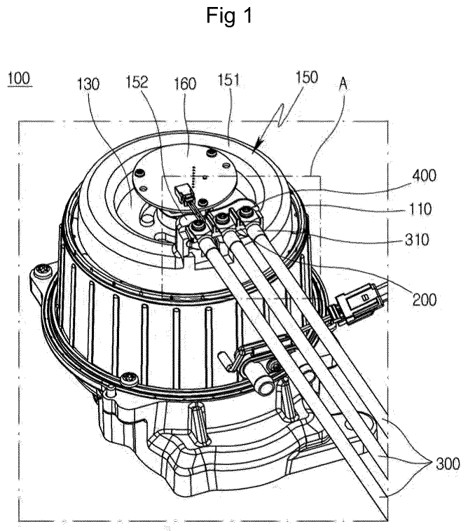

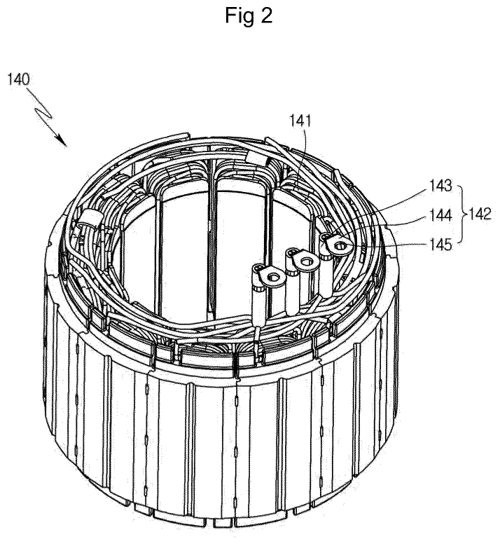

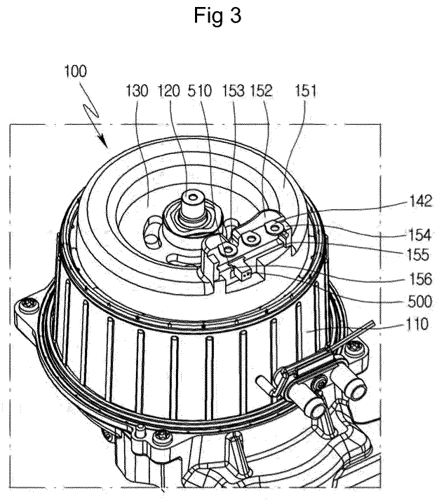

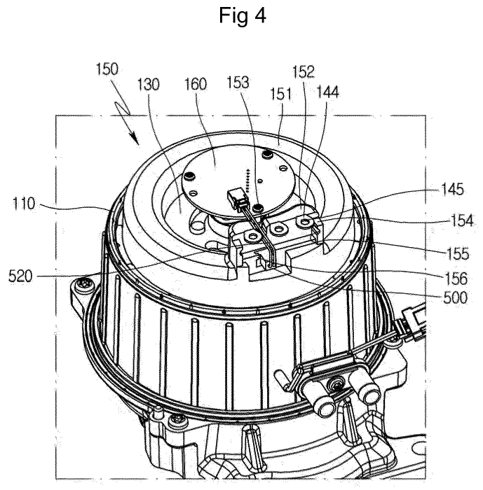

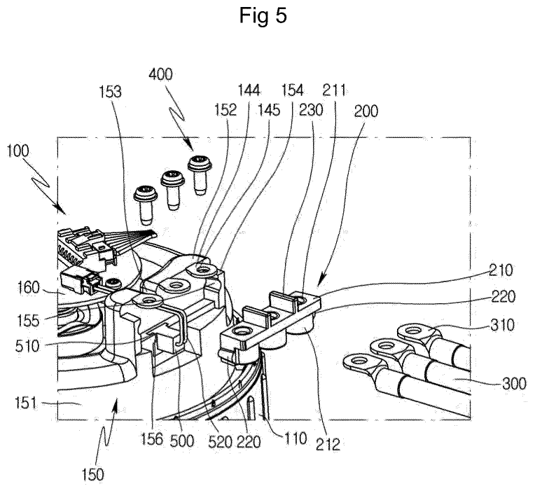

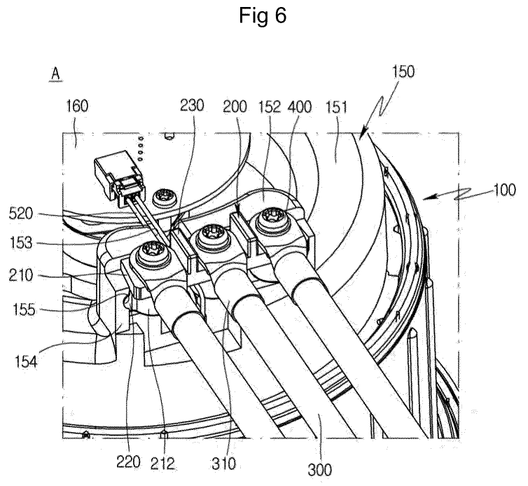

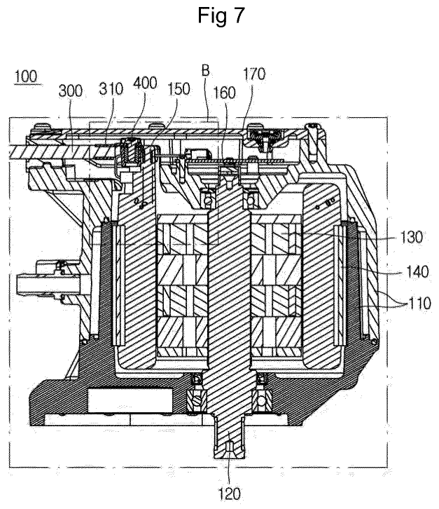

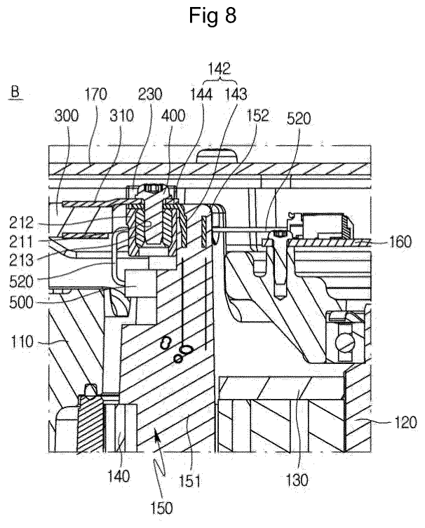

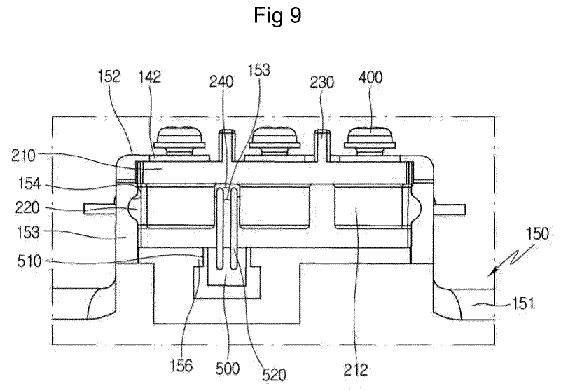

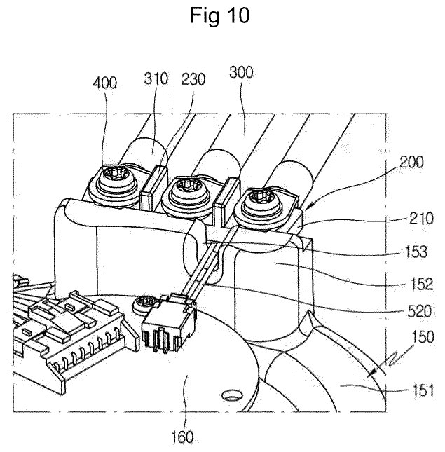

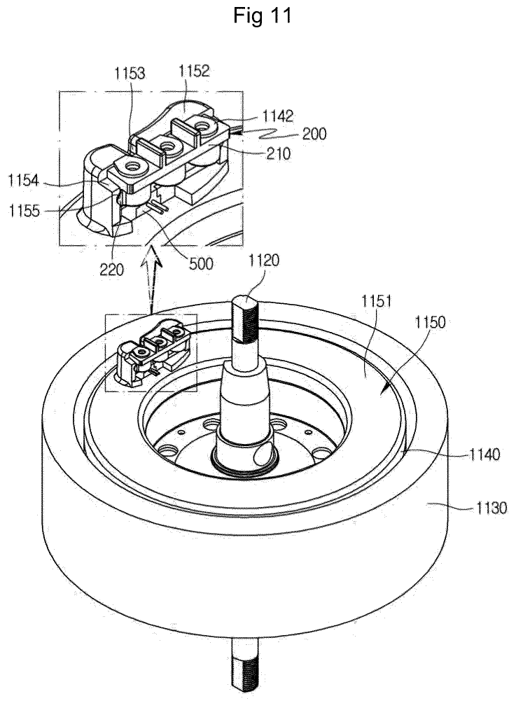

FIG. 1 is a perspective view of a motor having an inner rotor to which a connection structure of a motor and a cable according to an embodiment of the present disclosure is applied. FIG. 2 is a perspective view of a stator before a bolded body according to an embodiment of the present disclosure is molded thereover. FIG. 3 is a perspective view illustrating a state in which a molded body is molded over a stator of FIG. 2 and is assembled in a motor. FIG. 4 is a perspective view illustrating a state after a temperature sensor is connected to a circuit board from a state of FIG. 3. FIG. 5 is an exploded perspective view of a connection structure of a motor and a cable according to an embodiment of the present disclosure. FIG. 6 is an enlarged view of A part of FIG. 1. FIG. 7 is a cross-sectional view of a stator before a molded body according to an embodiment of the present disclosure is molded thereover. FIG. 8 is an enlarged view of B part of FIG. 7. FIGS. 9 to 10 are views illustrating a state in which a connection line of a temperature sensor is installed between a molded body and a terminal holder according to an embodiment of the present disclosure. FIG. 11 is a perspective view of a motor having an outer rotor to which a connection structure of a motor and a cable according to another embodiment of the present disclosure is applied.

As illustrated in the drawings, a connection structure of a motor and a cable according to the embodiment of the present disclosure includes a rotor 130, a motor 100 including a stator on which a coil 141 is wound and configured to rotate the rotor 130 according to power supply, a molded body 150 disposed to cover the stator 140 and the coil 141, provided at an end of the coil 141, and molded to expose a plurality of terminals 142, each of which being connected to a plurality of power cables 300, and a terminal holder 200 coupled to the molded body 150 and configured to fix connection between the terminal 142 and the power cable 300 through a plurality of fastening members 400 fastened by passing through the terminal 142 and the power cable 300.

The motor 100 includes the rotor 130 and the stator 140, and is classified into an outer rotor type in which the rotor 1130 is disposed outside the stator 1140, and an inner rotor type in which the rotor 130 is disposed inside the stator 140. In addition, the connection structure of the motor 100 and the cable is an invention which can be applied to both the motor 100 of the outer rotor type and the motor 100 of the inner rotor type.

The motor 100 illustrated in FIGS. 1 to 10 consists of the rotor 130 and the stator 140, and is the motor of the inner rotor type in which the rotor 130 is disposed inside the stator 140, and the connection structure of the motor 100 of the inner rotor type and the cable will be described with reference to the drawings.

The rotor 130 is formed to have a hollow shape, has a drive axis 120 inserted thereinto on an inside thereof and a plurality of magnets facing the stator 140, and is rotatably installed on an inside of the stator 140.

The stator 140 has a hollow-shaped core and a plurality of teeth on which the coil 141 is wound, and is configured to rotate the rotor 130 according to power supply.

In addition, the motor 100 has a motor housing 110 which encloses the rotor 130 and the stator 140, a circuit board 160 is mounted on one side of the motor housing 110, and a motor cover 170 is coupled to the motor housing 110, thereby protecting the circuit board 160.

The motor 100 includes the molded body 150 to dissipate heat because a temperature of the coil 141 increases when the motor 100 is driven, and a water-cooled motor structure for dissipating heat may be applied, in which a coolant is introduced into a side of the housing or a side of the stator.

The molded body 150 is disposed on one side in an axial direction of the stator 140 such that molded body 150 covers the stator 140 and the coil 141, and may be formed to enclose the overall coil 141 by being molded over an inside of the core of the stator 140.

The molded body 150 may be formed of a resin having heat conductivity, and improves heat transfer efficiency by rapidly transferring heat of the coil 141 to the stator 140 side as the molded body 150 encloses the coil 141 and contacts the stator 140.

At this instance, it is preferable that the molded body 150 is molded to enclose the overall coil 141 on one side in the axial direction of the stator 140, and is molded to be fixed in position so that the terminal 142, which is connected to an end of the coil 141 to connect the coil 141 and the power cable 300 to each other, and the molded body 150 do not interrupt each other and exposed to the outside.

The molded body 150 is molded to include the body 151, the protrusion 152, and the supporting wall 154.

The body 151 has a shape of a hollow, and covers the stator 140 and the coil 141 on one side of the stator 140, and the protrusion 152 is a part of the body 151 protruding toward one side, and allows an end of the coil 141 and a part of the terminal 142 to be embedded therein and exposes the part of the terminal 142.

The supporting wall 154 is provided as a pair, which supports both sides of the terminal holder 200 at both side sides in the circumferential direction of the protrusion 152.

The coil 141 is provided in plurality depending on a kind of the motor 100, and for example, as illustrated in the drawing, three kinds of coils are wound on the stator 140 in the present disclosure and three terminals 142 are fixed for each of the three kinds of coils, but the quantity is not limited thereto.

The terminal 142 consists of a fixing portion 143 which is fixed while covering an end of the plurality of coils 141, and a connecting portion 144 which is connected to the fixing portion 143 and has a shape of a plate on which a connecting hole 145, through which a fastening member 400 passes, is formed.

On an inner side of the fixing portion 143, an end of the coil 141 is fixed, and the fixing portion 143 is disposed on an inner side of the molded body 150 when the molded body 150 is molded.

The connecting portion 144 is formed to be bent to be perpendicular from the fixing portion 143, is disposed to face one side of the stator 140, and is exposed to the outside when the molded body 150 is molded so as to be connected to the power cable 300.

The connection structure of the motor 100 and the cable according to the present disclosure includes the terminal holder 200 and the fastening member 400 for connecting the connecting portion 144 of the terminal, which is exposed to the outside, and the power cable 300 to each other.

The terminal holder 200 is coupled to the molded body 150 and serves as a nut to which the fastening member is fastened.

The terminal holder 200 includes a supporting portion 210, which is coupled to the molded body 150 and allows the terminal 142 to be seated therein, and fastening holes 211, to which the plurality of fastening members 400 are screw-threaded, are formed on the supporting portion 210.

In addition, the terminal holder 200 may have a nut member 213, which has the fastening hole 211 formed on the supporting portion 210, or which is inserted into an insertion hole formed on the supporting portion 210 and has the fastening hole 211 formed on an inside thereof.

In addition, the terminal holder 200 has a plurality of partitions 230, which protrude from the supporting portion 210 and are disposed between the plurality of terminals 142.

The partitions 230 partition spaces so that the coil 141 and the terminal 142 are prevented from contacting each other, the plurality of power cables 300 are prevented from contacting each other, and the terminal 142 and the power cable 300 position in correct places on one surface of the supporting portion 210.

The fastening members 400 are provided as bolts and the like, and are fastened to each of the plurality of fastening holes 211, and fix the terminal 142 and the power cable 300 in place.

The fastening member 400 passes through a through hole formed on the connecting member 310 of the power cable 300 and the connecting hole 145 of the terminal 142 and then, is fastened to the fastening hole 211 of the terminal holder 200 so as to fix the power cable 300 to be in contact with the terminal 142.

The terminal holder 200 is assembled toward a circumferential inside from the outside such that the terminal holder 200 can be inserted into a portion between the supporting walls 154 of the molded body 150, and between the body 151 and the connecting portion 144 of the terminal 142.

In addition, the terminal holder 200 is coupled to the molded body 150 through a coupling structure so that the terminal holder 200 can be inserted into the molded body 150 and position stably.

For example, the coupling structure may be configured of a support projection 220 formed on any one among the terminal holder 200 and the molded body 150, and a groove 155 formed on the remaining one thereamong.

The support projection 220 and the groove 155 prevent the terminal holder 200 from axially moving after the terminal holder 200 is assembled toward the circumferential inside from the outside in the molded body 150, and prevent the terminal holder 200 from radially moving from the molded body 150 through the fastening member 400, which passes through the connecting hole 145 of the terminal and is fastened to the fastening hole 211 of the terminal holder 200.

The support projection 220 and the groove 155 are formed to correspond to each other, and may be formed to be radially long, and the groove 155 is provided to be opened radially outward so that the support projection 220 can be easily inserted thereinto.

In addition, as shown in the drawings, a cross-section of the support projection 220 is illustrated to be semi-circular, but is not limited thereto.

For example, as illustrated in the drawings, the groove 155 is formed in the supporting wall 154, and the support projection 220 is formed in the terminal holder 200, however, it is possible that the support projection 200 is formed in the supporting wall 154 and the groove 155 is formed in the terminal holder 200.

In addition, the motor 100 further includes a temperature sensor 500, which is insert-molded on an inside of the protrusion 152 so as to measure a temperature of the coil 141.

A fixing groove 510, which is recessed on both sides of the temperature sensor 500 and has a molded inside, is formed in order to make the temperature sensor 500 be insert-molded on an inside of the protrusion 152, and the support projection 156 which is molded over the fixing groove supports and fixes the temperature sensor 500.

The temperature sensor 500 may be, for example, an NCT sensor, and it is preferable that a measuring portion thereof is molded in a state of contacting the coil 141 when the stator 140 is molded so as to measure a temperature of the coil 141, but is not limited thereto.

The temperature sensor 500 is connected to the circuit board 160 through the connection line 520, and the circuit board 160 may be disposed to face the rotor 130 at a position axially spaced apart from one side of the rotor 130 disposed inside the stator 140 in case of the motor of the inner rotor type, or may the circuit board 160 may be disposed to be side by side on an outside of the rotor 130 disposed outside the stator 140 in case of the motor of the outer rotor type.

The circuit board 160 is protected by a motor cover 170 which is mounted on the motor housing 110 and coupled to the motor housing 110.

The connection line 520 may provide a temperature information of the coil 141 measured by the temperature sensor 500 and supply power for drive of the temperature sensor 500.

At this instance, the connection line 520 of the temperature sensor 500 is molded to be drawn out radially outward to prevent interruption with the rotor 130 which is assembled inside the stator 140, and is folded to be bent after being drawn out radially outward so that the connection line 520 can be connected to the circuit board 160 positioned on an upper side of the rotor 130.

The connection line 520 is positioned between the plurality of terminals 142, therefore, a structure for preventing interruption with the fastening member 400 or the terminal 142 is needed.

Referring to FIGS. 9 and 10, the protrusion 152 provides a through groove 153 which is partially recessed on one side which is a protruded tip end surface and into which the connection line 520 is inserted.

Further, an accommodation space 240 to prevent interruption with the connection line 520 is formed in the terminal holder 200.

The space 240 is provided on an opposite side to a side in which the terminal 142 is seated in the supporting portion 210, that is, the other side of the side in which the terminal 142 is seated in the supporting portion 210, so as to accommodate the connection line 520, as a recess of the other side, and the connection line 520 is inserted thereinto.

That is, the connection line 520 is disposed between the space 240 of the terminal holder 200 and the through groove 152 of the protrusion 152 to prevent interruption with the fastening member 400 or the terminal 142.

In addition, the terminal holder 200 may have a plurality of bosses 212 which is disposed to be spaced apart at a certain interval from each other on the opposite surface to a surface in which the terminal 142 is seated in the supporting portion 210, that is, the other surface thereof, so that the space 240, in which the connection line 520 is disposed, is formed between the bosses 212.

The bosses 212 are formed at positions which correspond to the plurality of fastening holes 211 and the fastening members 400 are fastened to the insides thereof.

Hereinafter, referring to FIGS. 1 to 5, an assembly process of the motor 100 to which the connection structure of the motor 100 and the cable is applied.

First, as illustrated in FIG. 2, in the stator 140, the coil 141 is wound on the plurality of teeth and the terminal 142 is connected to an end of the coil 141.

At this instance, the connecting portion 144 of the terminal 142 is formed to be bent perpendicularly to the fixing portion 143, and as the connecting portion 144 is supported on the mold when the molded body 150 is molded, the plurality of terminal 142 are spaced apart at a certain interval from each other.

In addition, by molding the connecting portion 144 and the temperature sensor 500 over the stator 140 in a state in which the connecting portion 144 and the temperature sensor 500 are supported on the mold, the molded body 150 is formed on one side of the stator 140 as illustrated in FIG. 3.

At this time, the connection line 520 of the temperature sensor 500 is drawn out radially outward, therefore, the rotor 130 may be positioned on an inside of the stator 140 on which the molded body 150 is formed, and thus, interruption does not occur when assembling the rotor 130.

On the outside of the stator 140 and the rotor 130, the motor housing 110 is coupled, and FIG. 3 shows a state in which the lower housing among the motor housing 110 is coupled thereto.

In addition, as illustrated in FIG. 4, the circuit board 160 is installed and the connection line 520 of the temperature sensor 500 is connected.

At this instance, it is preferable that the circuit board 160 is seated in the upper housing of the motor housing 110 to be assembled, and the drawing is illustrated with the upper housing omitted to show the assembled state.

As such, the connection line 520 of the temperature sensor 500 is drawn out radially outward and then bent to be folded so as to be inserted into the through groove 153 of the protrusion 152, and is connected to the circuit board 162, which is disposed to face one side of the rotor 130.

In addition, in the protrusion 152, the terminal holder 200, the power cable 300, and the fastening member 400 are assembled sequentially, and FIG. 5 illustrates the exploded perspective view thereof, and FIG. 1 illustrates a state after the assembly.

First, the terminal holder 200 is assembled in the molded body 150 by inserting the support projection 220 of the terminal holder 200 into the groove 155 formed in the supporting wall 154 of the molded body 150.

At this instance, as both sides of the terminal holder 200 are supported on the molded body 150, the support projection 220 is inserted into the groove 155 to fix the position in place.

When the terminal holder 200 is coupled to the molded body 150, the connecting portion 144 of the terminal 142 is seated in an upper side of the supporting portion 210, the partitions 230 are positioned between the connecting portions 144, and the connecting line 520 is positioned between the bosses 212.

In a state in which the fastening holes 211 of the terminal holder 200 and the connecting holes 145 correspond to each other, the connecting members 310 of the power cable 300 are seated in upper sides of the connecting portions 144 such that the through holes of the connecting member 310 correspond to the fastening holes 211 and the connecting holes 145, and then, the fastening members 400 are screw-threaded to the fastening holes 211 after passing through the through hole and the connecting hole 145.

It is preferable that the fastening members 400 are sufficiently screw-threaded to the fastening hole 211 so that the connecting portion 144 and the connecting member 310 of the power cable 300 are electrically connected to each other.

In addition, an electrical test such as resistance measurement is performed to check connection between the coil 141 and the power cable 300.

In addition, in the above-described embodiment, the present disclosure has described the connection structure of the motor 100 of the inner rotor type, of which the rotor 130 is disposed on the inner side of the stator 140, and the cable, however, the connection structure of the motor 100 and the cable according to the present disclosure may be applied to a motor 1100 of the outer rotor type, of which the rotor 130 is disposed on an outer side of the stator 140 in the same way as well, and such application falls under the scope of the present disclosure.

In FIG. 11, the motor 1100 of the outer rotor type, to which a connection structure of a motor and a cable according to another embodiment of the present disclosure is applied, is illustrated.

In the motor 1100 of the outer rotor type, a drive axis 1120 is inserted into an inner side of a stator 1140, and a rotor 1130 is disposed outside the stator 1140 to rotate with respect to the stator 1140 when the rotor 1130 is driven.

In addition, a molded body 1150 is molded to cover the stator 1140 and the coil on one side of the stator 1140.

Further, the molded body 1150 has a body 1151 having a hollow shape and covering a part of the stator 1140; a protrusion 1152 being a part of the body 1151 and configured to protrude toward one side, allowing an end of the coil and a part of a terminal 1142 to be embedded therein; and a pair of supporting walls 1153 supporting both sides of the terminal holder 200 on both circumferential sides of the protrusion 1152.

The terminal holder 200 being coupled to the molded body 1150 is the same as the terminal holder 200, which is coupled to the above-described motor 100 of the inner rotor type, therefore, the detailed description of the terminal holder 200 will be omitted.

In addition, in the motor 1100 of the outer rotor type, the rotor 1130 is disposed outside the stator 1140, accordingly, the terminal holder 200 is coupled to the molded body 1150 outward from a circumferential inside.

Moreover, the connection line 520 of the temperature sensor 500 is insert-molded in the molded body 150 such that the connection line 520 is drawn out radially outward, and is bent to be folded so as to be connected to the circuit board 160 disposed outside the rotor 1130.

According to the embodiments of the present disclosure having the above-mentioned shape and structure, there is an effect that only the stator is molded thereover to form the molded body, without an additional connector housing, and the overall volume of the motor is reduced.

In addition, there is an effect that the motor housing can be made of a different material from that of the molded body because the motor housing can be provided separately, and the coolant flow path is formed inside the motor housing or between the stator and the motor housing, and the structure can be applied to the water-cooled motor structure.

Furthermore, the present disclosure provides the terminal holder which is mechanically assembled after the molded body is molded thereover, there is an effect that the manufacturing process is reduced, the quantity of components is reduced, and the power cable and the coil embedded in the molded body can be stably connected to each other through a simple configuration.

Although components included in the implementation of the present disclosure are described as being combined to one, or as being operated to operate, the present disclosure is not necessarily limited to such an implementation, and these components may operate by being selectively combined to one or more within the purpose range of the present disclosure.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

[Reference Numerals]

| | |
|---|---|
| 100, 1100: motor | 110: motor housing |
| 120, 1120: drive axis | 130,1130: rotor |
| 140, 1140: stator | 141: coil |
| 142, 1142: terminal | 150, 1150: molded body |
| 151, 1151: body | 152, 1152: protrusion |
| 153, 1153: through groove | 154, 1154: supporting wall |
| 155, 1155: groove | 160: circuit board |
| 170: motor cover | 200: terminal holder |
| 210: supporting portion | 211: fastening hole |
| 212: boss | 220: support projection |
| 230: partition | 240: space |
| 300: power cable | 400: fastening member |
| 500: temperature sensor | 510: fixing groove |
| 520: connection line | |

1. A connection structure of a motor and a cable, comprising:
a motor comprising a rotor and a stator on which a coil being wound and configured to rotate the rotor according to power supply;
a molded body disposed to cover the stator and the coil, provided at an end of the coil, and molded to expose a plurality of terminals, each of which being connected to a plurality of power cables; and
a terminal holder coupled to the molded body and configured to fix connection between the terminal and the power cable through a plurality of fastening members fastened by passing through the terminal and the power cable.

2. The connection structure of claim 1,
wherein the molded body comprises:
a body having a hollow shape and configured to cover the stator and the coil at one side of the stator;
a protrusion being a part of the body and configured to protrude toward one side, to allow an end of the coil and a part of the terminal to be embedded therein and to expose a part of the terminal; and
a pair of supporting walls configured to support both ends of the terminal holder at both circumferential ends of the protrusion.

3. The connection structure of claim 2,
wherein the terminal holder comprises:
a supporting portion coupled to the molded body to allow the terminal to be seated therein, and on which a plurality of fastening holes allowing the plurality of fastening members to be fastened thereto being formed.

4. The connection structure of claim 3,
wherein the molded body has grooves recessed on inner sides of the pair of supporting walls, and
wherein the terminal holder has a support projection which projects from a surface supported on the supporting wall and are inserted into the groove.

5. The connection structure of claim 3,
wherein the terminal holder further comprises:
a plurality of partitions protruding from the supporting portion and disposed between the plurality of terminals.

6. The connection structure of claim 3,
wherein the motor further comprises:
a temperature sensor insert-molded on an inner side of the protrusion to measure a temperature of the coil and connected to a circuit board through a connection line.

7. The connection structure of claim 6,
wherein the terminal holder has a space configured to accommodate the connection line on a side opposite to a side of the supporting portion in which the terminal being seated so as to prevent interruption with the connection line.

8. The connection structure of claim 6,
wherein the terminal holder comprises:
a plurality of bosses formed on an opposite surface to the side of the supporting portion in which the terminal being seated, formed at positions corresponding to the plurality of fastening holes to allow the fastening members to be fastened thereto on insides, and spaced apart from each other at a certain interval so as to prevent interruption with the connection line.

9. The connection structure of claim 6,
wherein the connection line is drawn out from an opposite surface facing the rotor at the temperature sensor so as to prevent interruption with the rotor, and folded to be bent and connected to the circuit board.

10. The connection structure of claim 6,
wherein the protrusion has a through groove partially recessed at a protruding tip end surface thereof and allowing the connection line to be inserted thereinto.

11. The connection structure of claim 1,
wherein the terminal comprises:
a fixing portion having a hollow shape surrounding an end of the coil and fixed at the end of the coil; and
a connecting portion connected to the fixing portion, having a plate shape facing one surface of the stator, and exposed to an outside to be connected to the power cable when the molded body is molded.
